(19) United States
(12) Patent Application Publication
(10) Pub. No.: US 2021/0027645 A1
(43) Pub. Date: Jan. 28, 2021

(54) Collaborative Educational E-Learning Multi and Single Device, Supplemental Pedagogical Data Management UX/UI System Technology Platform Using Immersive Interactive Mixed Reality

(71) Applicant: Jody Sarah Nicol, Fairfax, VA (US)

(72) Inventor: Jody Sarah Nicol, Fairfax, VA (US)

(21) Appl. No.: 16/939,643

(22) Filed: Aug. 25, 2020

Related U.S. Application Data
(60) Provisional application No. 62/879,027, filed on Jul. 26, 2019.

(51) Int. Cl. G09B 5/12; G06T 19/00; H04L 29/08

(52) U.S. Cl. CPC G09B 5/12; H04L 67/12; G06T 19/006

(57) ABSTRACT

The present invention relates to a secure cloud-based semi-open-ended interactive platform application/website, comprising of multi-user/single user, mobile device friendly, virtual reality (VR) and augmented (AR) mixed reality (MR) Information Technology (IT) system for threaded collaboration, (GPS) geofencing immersive education, facilitating children and adult interactive training and e-learning. Where-in problem-based learning, and technology and the learning sciences provides users to investigate cognitive and social aspects of collaborative knowledge construction, computer supported collaborative, process and data management system learning. Open partial for UI/UX personalization and cooperation according to the present invention methods, adds a mobile interface for providing a personal and multi-user space to share curated information within the secure technology platform's central repository.

### BACKGROUND OF THE INVENTION

### Field of the Invention

Authentic, place-based, educational, collaborative, immersive mixed reality, platform, (FIG. 5(A-G)) Creating virtual learning experiences, leveraging global collaboration through sharing of; artifacts, life sciences branching, collection of via mixed reality-based applications. Mixed reality broadly includes but not limited to; Geographical-Mapping-Geofencing, Virtual Reality, Gamification, Artificial Intelligence, and Augmented Reality technology, which allows a user to see or otherwise sense an interactive computer-generated virtual world integrated with the real world. The “real world” is the environment that an observer can see, feel, hear, taste, or smell using the observer's own senses. The “virtual world” is defined as a generated environment stored in a storage medium or calculated using a processor. There are a number of situations in which it would be advantageous to superimpose computer-generated information on a scene being viewed by a human viewer. For example, a user learning about climate change and its effects on eco-systems would benefit by having the relevant portion of geographical coordinates for geo-mapping-fencing (GPS) technology which creates a virtual geographic boundary, enabling software to trigger a response when a mobile device enters or leaves a particular area, and provides an indoor/outdoor experience for large number of users. (FIG. 1-4) Typically, these systems display pertinent information that allows the user's view of the real world to be enhanced or added to by “projecting” within the inventions platform computer generated annotations or objects.

However, facilitators face challenges when implementing place-based learning for it may require significant time and resources; sometimes finding effective settings to present the subject is impossible. Facilitators/educators then must resort to traditional text and flat representations of subjects and related environments—approaches that create cognitive dissonance for many students. Younger learners, especially, find it difficult to transfer two-dimensional (2D) representations into a 3D model in which they can contextualize a problem. These limitations have become much more urgent during the coronavirus pandemic.

Millions of U.S. students have been displaced from classrooms and have become remote learners, not by choice. The coronavirus pandemic reinforces the need for virtual learning technologies and initiatives that focus on developing and understanding the complex interrelationships between subject matter and societal issues. Facilitators/educators need high-quality resources and tools to address supplemental distinctions between physical indoor classroom and outdoor e-learning which help them effectively facilitate authentic place-based learning which transform and enhance remote learning capabilities.

As the world grows more interconnected, the importance of understanding global problems only increases.

### BRIEF SUMMARY OF THE INVENTION

According to Statista research, the size of the e-learning market will grow and reach 243.8 billion U.S. dollars in 2022. The following issues are emerging with particular importance to future collaboration and research in distance learner support: 1) the lack of innovation research on cost-effectiveness; 2) the lack of empirical research; and 3) the need for a learner-centered approach in designing and implementing learner support. Future research should focus more on developing and refining methods for cost-benefit analysis of learner support, developing a general framework of the learner support model, and developing systematic methods to identify, analyze, synthesize, and assess the needs of distance learners.

The need for learner support in distance education comes from the recognition that distance learning is often mediated by networked computers with individualistic interfaces that require learners to work alone during most of the learning process. Since neither the facilitator/instructor nor their peers are physically present for help and direct access to learning resources and facilities is somewhat limited, distance learners have unique needs that go far beyond the existing student support services in traditional education settings. Many researchers and practitioners have long suggested that successful student learning in distance education settings can be achieved only through appropriate support services.

As more and more secondary, post-secondary and workforce training institutions are offering distance education programs or planning to do so in the near future, there is a great need for research on designing and implementing user/learner supplemental support services. Nevertheless, the majority of existing studies on learner support are based on large-scale correspondence programs (i.e., Open University in U.K.), and few of them provide a comprehensive analysis of supplemental support services in web-based environments or guidelines for establishing and managing user/learner support systems. There are several forces underlying the gap between research and the practice of user/learner supplemental support, in particular there are two reasons to explain the situation. First, user/learner support has been perceived as peripheral to the ‘real business of distance education which is developing course materials. Second, many researchers tend not to consider user/learner support as a suitable topic for research since it is contingent on local circumstances and thus not easy to generalize the findings. These points may have been relevant in the past when distance education was viewed as an inferior alternative to traditional face-to-face education and the emphasis was on the product, rather than the process.

The public awareness of distance education is changing, if it has not already changed, and distance education is considered as a major and increasingly important component in secondary, higher education and workforce training these days. Distance user/learners have become more sophisticated, diversified, and demanding than ever, and they expect a lot more than well-designed learning material. More importantly, the competition among distance education providers is such that if an institution fails to satisfy the students, it will lose them to one of its competitors. Thus, many institutions offering distance education programs are struggling to better meet the needs of their students. Unfortunately, previous research studies on user/learner support are not able to provide much guidance for the institutions to cope with these problems, and all the parties involved in distance education are learning the lessons in a hard way—by trial and error.

### BRIEF DESCRIPTION OF THE DRAWINGS

FIG. 1 Narrative:

Illustrates the connected events particular to the field of environmental and science nomenclatures.

FIG. 2 Observation Learning Methods:

Demonstrates an interactive virtual world integration with the real world in which the observer aligns the learning initiatives with strategic goals, the ability to search, explore and discover learning opportunities.

FIG. 3 Journey:

Shows how a series of path identifiers and methods for trainers/facilitators implement and direct users/learners to follow geographical coordinates and respond when a mobile device enters or leaves a particular area.

FIG. 4 Journey Collection:

Demonstrates how interaction allows adaptability for user's/learners to assemble two or more elements, post evaluations, utilize mixed reality tools to enhance and demonstrate broader social, cultural economic and policy arrangements which align with learning subject matter benchmarks and capabilities.

FIG. 5(A) Collaborative Immersive Mixed Reality Educational Platform:

Shows a flow chart illustrating creative relevant opportunities to practice/apply knowledge within an exemplary embodiment for digital supplemental learning, cloud based tool, multi-user, active Learning Experience Platform (LXP) (personalized, social online learning in a single portal), Instructor Lead Training (ILT), Virtual Instructor Led Training (VLT) domain ontology for contextual encouragement and communication, which builds learner confidence, engagement, and creates a secure blended learning community.

FIG. 5(B) User Input, Output, Actions:

Shows an illustration of a cloud-based tool, multi-user, multi-device ecosystem for easy accessibility and navigations to promote learning innovation.

FIG. 5(C) Application Programming Interface (API):

Shows a flow chart illustrating cooperative training in conjunction with Application Programming Interfaces (API's), Mixed Reality (MR), Artificial Intelligence (AI), and Augmented Reality (AR).

FIG. 5(D) User Customize Personalization Authorship:

Shows the flexibility for facilitators/trainers to adapt syllabus and lessons within the platform and user/learners edit content. Semantic annotations for personalization and authorship.

FIG. 5(E) User Interface Collaboration Cohort:

illustrates an interactive informal peer-to-peer creative collaboration community for exchanging social pathways which align with the subject's vision and greater mind sharing innovation impact.

FIG. 5(F) Open Source Links:

Shows an illustration consisting of examples, but not limited to Open Source Software (OSS) that is designed to be publicly accessible, for trainers and learners to see, modify, and distribute within the platform's lesson plan and syllabus.

FIG. 5(G) Repository Library Centralized Optimization Resource e-learning:

Shows an illustration chart for an online Learning Object Repository (LOR); for storing, managing and sharing learning resources, standards, and goals within the platform for Learning Management System (LMS); and, a Content Management System (CMS) application that can be used to manage the creation and modification of digital content, and Web Content Management (WCM).

### THE PURPOSE OF THIS INVENTION

Is to address the current gaps in curated, engaging, subject matter expert distance learning which supplement facilitator's syllabus and suggest recommendations. Based on an extensive review three issues have emerged as the most problematic areas in distant user/learning supplemental innovation research on user/learner support: 1) the cost-effectiveness of user/learner support; 2) the lack of empirical research and the difficulties in generalizing innovation and research findings as a result; and 3) the need for a user/learner-centered approach. The invention tackles these issues with greater depth which help enhance understanding of user/learner support in distance education and advance innovation research for sustainable solutions.

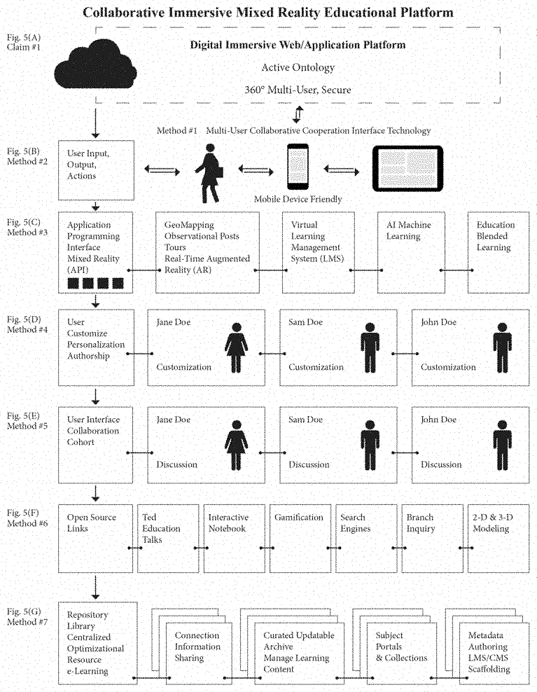

From a topical perspective and as an example of the website/application; the invention's educational focus will comprise industries systemic complex systems, features and human error and how industries affect environmental, biodiversity eco-systems with potential severe or catastrophic consequences. As resources are quickly depleted and the environment becomes increasingly contaminated, it is imperative that we develop an awareness of the impact we are having on our planet. Environmentalism must be more than a concept if inhabitants of our planet are to continue to enjoy and share the abundant resources that the Earth provides. From the earliest age, learners need to be both acquainted with and practice concepts related to conservation and alternative resource development. The invention provides this opportunity through high-quality, interactive, engaging, immersive platform for learners for all ages. From a holistic perspective the mission of the invention can be summarized as providing an engaging platform through which users/learners engaged in a blended, collaborative approach to discover sustainable innovation solutions, with a focus around climate change inquiry. Notably, the invention has been conceived as a secure semi-open-ended platform that encourages multi-disciplinary inquiry to promote learning, (FIG. 5(A-G)) In practical terms this means that branched inquiry is developed as a routine part of user/leaner discourse, making science, technology, engineering, art, math (STEAM) integration a given. Additional API's (application program interface) for example: computing interface which defines interactions between multiple software intermediaries, spatial patterns, and gamification as layer, could also increase user/learner responsiveness. At a philosophical level, the invention's diverse interaction sets will provide the basis for encouraging stewardship of Mother Earth.

### SUMMARY OF THE INVENTION

The present invention is a remote UI/UX, (UX design refers to user experience design, while UI design stands for user interface design). Both of these are crucial to an IT product and need to work closely together. Despite being very integral to each other, the roles themselves are quite different, involving distinct processes, collaborative, educational, immersive mixed reality, multi-user, multi/single mobile friendly, secure application/website platform. Users are offered relevant several ready-to-use themes with stacked built-in functional features such as; environmental-biodiversity ecosystems, STEAM (Science, Technology, Engineering, Arts, Math) on climate change. Within the platform's framework there are opportunities which provides facilitators/educators (i) Web-Based Course Curation tools for subject matter experts and educators with the ability to implement multi-media based lesson plans, and (II) a Mobile e-learning application that employs mixed reality techniques to support in situ users/learners conducting field science exercises comprising but not limited to geo-mapping fencing features and (iii) adaptive reusable tools for compiling/experiencing course integrated content and access to databases. (FIG. 5(C), 5(F))

The educational e-learning platform is a set of interactive custom and online services that provides the users to study and interact online while providing users with tools, information and resources i.e.; (augmented, virtual mixed reality, open source hyperlinks, coding, API's, books, videos, etc.) for syllabus supplemental studying. (FIG. 5(C), 5(F))

The complexity of the platform's calculation is a structure of several categories with project interdependencies, every one of them contributes to distance learning globalization education, interim algorithm progress of the user, and individual results. (FIG. 5(G))

The invention brings users and technology from several sectors to create an immersive experience in which users can interact, engage in a mixed reality learning framework to explore topics, share information, and collaborate with peers on a global basis. The website/application allows users to have mixed reality field experiences, with or without connectivity, in which rich data related to their environment guides exploration and allows students to capture digital information that can then be uploaded to a secure central repository. (FIG. 5(C), 5(G)) Users/learners record their observations about the subject within the website/application. The observations then become accessible to other; facilitators/educators and users/learners which use the compiled findings to undertake data-based research. This application enhances the educator's/facilitator's (teacher's, parent's) toolkit to leverage local, real-world resources and support much-needed collaborative, effective, innovative solutions. More advanced users/learners can access additional findings, re-evaluate and further expand global discovery.

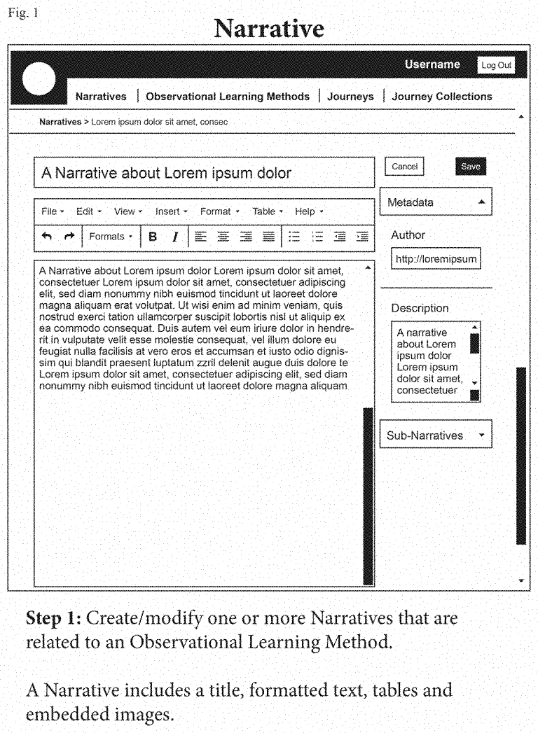

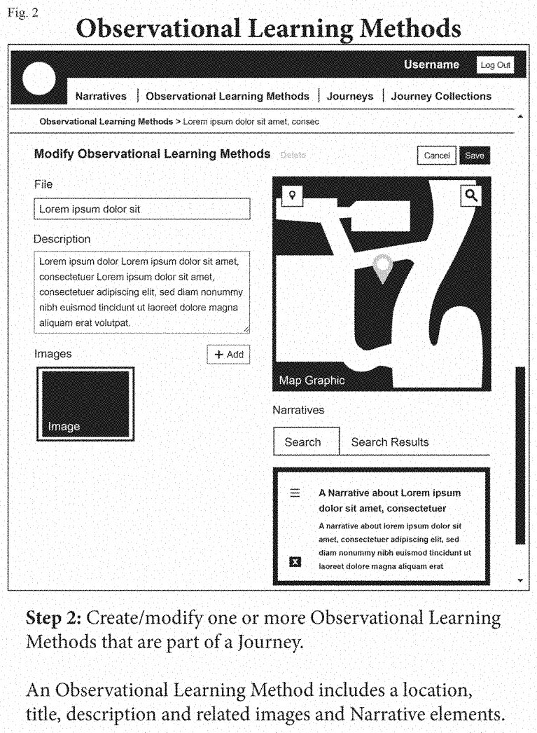

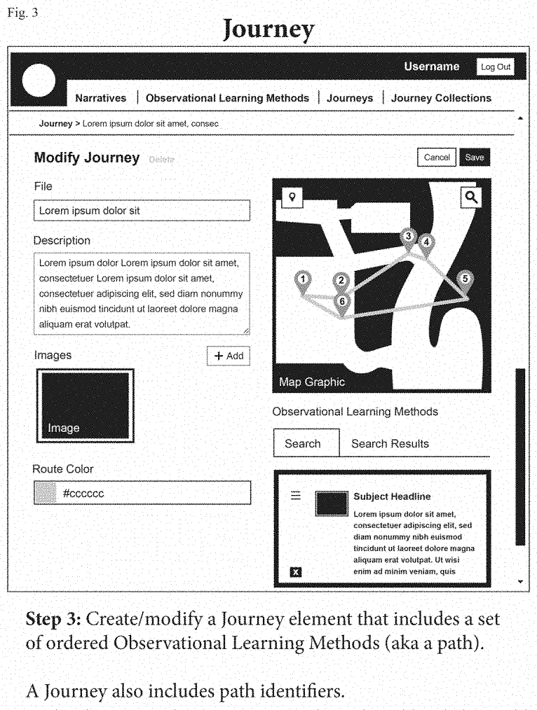

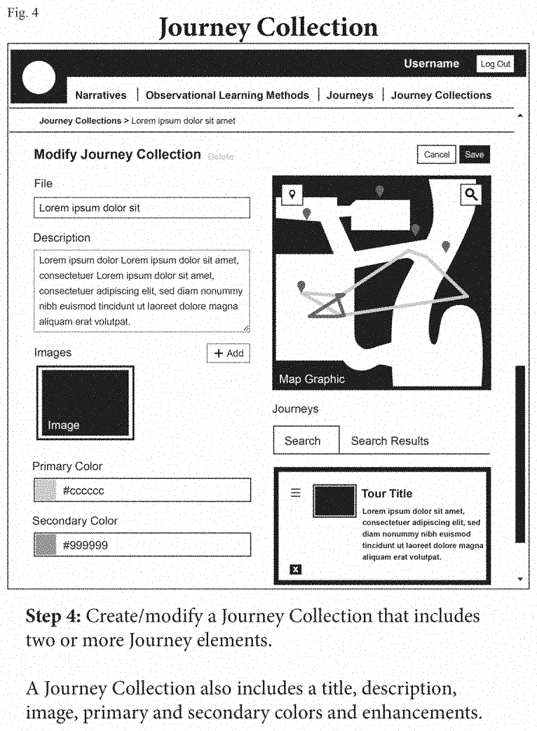

The cloud-based secure platform accesses qualitive, curated, database functionality storage, within the platform's centralized recourse repository (wiki-like library). Findings are then be shared through a system that sits atop a 360-video portal can leverage any type of media as a base, which can in turn be enhanced to provide dimensionality as well as interactivity. An example of this would be starting with the Google Earth application, which is accessed by an open set of Application Protocol Interfaces (API's) and creating a 360 rendering of the same. The interactive rendering in the portal is constructed as a grid to allow tags to be placed at any point therein. Using the below example, the rendering of the Earth, would allow for users/learner to pin-point a location and mark it. (FIG. 1-4)

After an area has been selected on the portal level, additional information can be added. Again, using the above example a series of photographs or videos could be uploaded by the user creating the point. In turn another viewer could select that point and see any information that had been uploaded in relation to said point. Information sharing systems, such as blogs and wikis, are connected to the tags as well to allow for the provisioning of additional information and discussions by all participants. (FIG. 5(C-D))

The invention platform is built on a cloud-based infrastructure to ensure scalability and uninterrupted service. Depending on the location of user/learner groups, the invention distributes across appropriate geographic nodes to minimize latency. Login credentials are used to access the system and allow for user/learner postings. Listings of learners are provided by clients, who pay annual subscription rates for usage.

The subsequent repository of user interactions is captured in a wiki-type format. This material enables facilitators/teachers/users to curate and facilitate engaging, hands-on, mixed reality, learning experiences which is continually updated to reflect changes in topic knowledge, with associated commentary available through deep linking. Combining these two elements allow for the inclusion of both trusted sources and a living body of knowledge that continue to engage user/learners overtime. (FIG. 5(G))

### Market Differentiation:

There are currently volumes of content related to environmental issues on the market, many of which allow users from various areas of the globe to share experiences. Likewise, there are apps that allow for guided facilitation of learning in the field. However, the invention provides the ability for users to have detailed geospatial information related to any area to reside natively on their mobile device and leverage this information for enhanced field experiences. Once content is obtained and shared, the invention provides guided pathways that help users/learners create collaborative solutions that span multiple disciplines and accounts for multicultural perspectives. This pairing of technology and multi-disciplinary pedagogy creates a learning environment that is unique when compared to siloed alternatives that are currently in the market.

The invention consists of three layers. The top layer, the mixed reality layer, is the user interface and will serve as the initial point of interaction for the user. This will be accessed via a webpage and/or an application and is comprised of renderings of applications that are available from other web services and accessed via customized application program interface (API's). For example, within the platform a mixed reality layer comprising of a graphical user interface representing the environment or subject matter, being accessed and will be supported by standard RESTful services implementations, (RESTful API is an API that conforms to the representational state transfer or REST model. RESTful APIs are sometimes easier for developers to use because they have a familiar syntax and set of protocols) such that a user may access and interact with those representations and allow users to complete actions such as plotting data, setting tags, and/or creating overlays. (FIG. 5(A-F))

The second layer, the content repository, provides storage for images uploaded by a user and allows them to be arranged in a manner of their choosing. This layer will be built with standard HTML, JavaScript, and other web development languages. The content repository will store all uploaded digital files in a standard content management system and will be viewable through the mixed reality layer, with changes and additions displayed in real time. Upon creation of an object in the content repository, a connector includes a social media component as defined in the next section. (FIG. 5(G))

The third layer, the social media layer, utilizes common social media components and applications, such as wiki's and/or blogs. This is connected to individual objects in the content media layer via RESTful API's and display contents, which in turn are consumed by the mixed reality layer. The social media layer is connected, by standard connectors to a relational database with the precise configuration is dependent upon the social media service being consumed. (FIG. 5(D))

The invention's framework and all of the components described above will be hosted on cloud-based services such as Amazon Web Services and/or Microsoft Azure. The invention's framework exists in a multi-tenant state so that instances may be created on-demand and provisioned to accompany other learning systems or as a stand-alone product.

The invention platform's R&D effort is, “a systematic application of knowledge . . . ”. The invention's technical objective is an innovative mobile e-learning system that enhances critical STEAM education by integrating classroom experiences with immersive, in situ outdoor learning experiences, where students employ the scientific method to better understand major problems that are now occurring on a global scale. The invention's methodology takes emergent “citizen scientists” to the field with science-based, mixed-reality education, e-learning tools, where they can address key scientific questions, measure and observe features and phenomena in their locale, and then bring these results back into the classroom/lab for collaboration, synthesis, analysis, evaluation, and reporting. The approach of seamlessly blending outdoor learning with classroom/lab activities allow students to research local conditions and issues to achieve a deeper understanding of complex global problems such as overpopulation, climate change, and food/water safety and supply. (FIG. 1-4)

Globally aware facilitators/educators seek more effective tools and methods for preparing their user/learner for these daunting global problems. This challenge must be met with new, innovative learning solutions. The invention's approach centers on three core ideas for overcoming this challenge: 1) evidence of these problems can be found in every user/leaner locale, so each user/learner can actively participate in relevant scientific investigations; 2) scientist-educators can employ web tools to curate instructional syllabi for user/learner mobile devices, so that independent and/or collaborating user/learner can in turn conduct field exercises/experiments; and 3) authentic, “hands-on” field science, with mobile e-learning tools that apply the scientific method, will tap into user/learner passions to make a difference in the world. Once user/learner develop this deeper connection with the greater world, and better understand the power of STEAM (science, technology, engineering, arts, and math), they will be better equipped to make a difference.

Mixed reality, geo-mapping, artificial intelligence collaborative immersive education, currently do not intersect, thus poising the invention's platform to bridge cultures, encourage thought, and present environmental ecosystems concepts through affordable, user-friendly, multi-device, that inspire innovated sustainable solutions in a technological cloud secure platform.

The invention platform is summarized as set of tools that provide for:
Knowledgeable subject matter experts, facilitators, educators and users/learners to craft place-based experiences using Curation Tools.
Users embark upon expertly curated experiences, in the form of journeys and observational learning methods within the inventions platform's Mobile Application.
Geospatial data sharing and analysis services, from cloud providers.
Performance in both online and offline/intermittent connectivity modes.
The Narratives and Sharing example use case centers around a set of hierarchical concepts or “Elements”, “Narratives”, “Observational Learning Methods”, “Journeys”, and “Journey Collections”. (FIG. 1-4)

There are three distinct scenarios, or use cases, that are a part of the Invention within the Platform:
1. Narratives and Sharing
2. Education
3. Regional Disaster Response

Narratives and Sharing use case includes the following capabilities: (FIG. 1-4)
Facilitators/educators log into the web-based Curation interface (“Curator”) using Google authentication, or with a system-specific username and password.
Facilitators/educators create location-relevant Stories about a person, place, or thing, using a rich text editor within the Curator.
Facilitators/educators capture pictures, videos, and audio, and insert them into Stories, or associate them at any other level in the hierarchy Elements using the Curator.
Facilitators/educators associate rich and relevant narrations with one or more Observational Learning Methods using the Curator.
Facilitators/educators group a specific set of Observational Learning Methods into a Journey using the Curator.
Facilitators/educators group a set of Journeys into a Journey Collection using the Curator.
Facilitators/educators/users publish the Journeys and/or Journey Collections using the Curator.
Users browse, select, and access expert-curated Journeys to be experienced at facilitators/educators or users own pace, convenience, and desired level of detail using the inventions immersive Platform Mobile Application.
Users navigate to and between an ordered set of Observational Learning Methods with paths, and travel times, all obtained and integrated from Google Maps using the Mobile Application.
Users can tap on an Observational Learning Method; the details will be displayed.
Users can select to use turn-by-turn navigation, via seamless re-direction to Google Maps.
Users can create a custom “Excursion” by selecting and ordering a subset of Observational Learning Methods from a particular Journey using the Mobile Application and create (and delete) additional markers that become part of the Excursion route.
Users, who operate in disconnected environments, can take advantage of “Download-and-go” capabilities to operate in offline mode on mobile application in disconnected environments using the Mobile Application.
Users can listen to Narratives by using native Google automated narration using the Mobile Application.
Users can “backup” all Narratives, Observational Learning Methods, Journeys, and Journey Collections from one instance of the application, and can upload the Elements to another application instance.

The invention's approach centers on three core ideas for overcoming this challenge: 1) evidence of these problems can be found in every user/leaner locale, so each user/learner can actively participate in relevant scientific investigations; 2) scientist-educators can employ web tools to curate instructional syllabi for user/learner mobile devices, so that independent and/or collaborating user/learner can in turn conduct field exercises/experiments; and 3) authentic, “hands-on” field science, with mobile e-learning tools that apply the scientific method, will tap into user/learner passions to make a difference in the world. Once user/learner develop this deeper connection with the greater world, and better understand the power of STEAM (science, technology, engineering, arts, and math), they will be better equipped to make a difference.

Mixed reality, geo-mapping, artificial intelligence collaborative immersive education, currently do not intersect, thus poising the invention's platform to bridge cultures, encourage thought, and present environmental ecosystems concepts through affordable, user-friendly, multi-device, that inspire innovated sustainable solutions in a technological cloud secure platform.

The invention platform is summarized as set of tools that provide for:
Knowledgeable subject matter experts, facilitators, educators and users/learners to craft place-based experiences using Curation Tools.
Users embark upon expertly curated experiences, in the form of Journeys and observational learning methods within the inventions platform's Mobile Application.
Geospatial data sharing and analysis services, from cloud providers.
Performance in both online and offline/intermittent connectivity modes.

The Narrative and Sharing example use case centers around a set of hierarchical concepts or “Elements”, “Narratives”, “Observational Learning Methods”, “Journeys”, and “Journey Collections”

Capabilities of the Narratives and Sharing use case include:
Mixed Reality Component: Display the former buildings and environments that once stood at a specific location in a period of time, particularly for places with historical significance, to see how the area and environment has changed through time.
Image Recognition for Narrative Upload: After a user takes a photo of text, the application scans the image, and uploads its text into a story, which is beneficial for users who wish to upload first-hand accounts of historical pieces or upload already-curated written account.
Smart Assistant Integration: Employ a smart assistant for easy access to information about a given Journey, Observational Learning Method, etc.; Users wishes to utilize a hands-free approach to their Journey, relying on voice-activated technology.
Extract information from already-curated data: Build extracted data into a service that provides the user information about a given topic; This is valuable in developing smart assistant integration into the application, which provides a greater amount of data from which the assistant can access and present to the user.
Search for Nearby Journeys or Observational Learning Methods: Use geofencing to find curated data near the user, building off the integration of a smart assistant within the application for a voice-activated search of relevant pieces of history located around them in a new or unfamiliar area.
Rating & Reviewing of Journeys and Observational Learning Methods: Allow users to rate Observational Learning Methods and Journeys and leave comments or reviews, providing unfamiliar users with more information to help them select the “best” Journeys and create Excursions with only the most popular Observational Learning Methods.
Google Image Search within the application: Implement a Google Image lookup service within the application for less complicated image fetching from relevant existing system images (given information about a Journey, Observational Learning Method, or Narrative); As opposed to users grabbing images from their local storage, users could perform an image search within the “Media Model” component to then add the image to the Element being created or modified.
Leverage Social Media: Allows user authentication through various social media platforms (Instagram, Twitter, Facebook), which facilitates broader sharing of Journeys and Journey collections and increases of exposure of the system.

The Regional Disaster Response use case of the following functional capabilities:
Facilitators/educators/users create collaborative mission map.
Facilitators/educators/users, work with colleagues to coordinate regionalized information.
Facilitators/educators/users, tailorable team-specific operational tasking view.
Facilitators/educators/users, temporal, location specific tasks with metadata.
Facilitators/educators/users, mobile updates to/from collaborative maps (smart synchronization)/data queued offline until connected to network. (“smart-sync”).
Facilitators/educators/users, common-operating-picture (“real-time map”) through real-time data federation.
Facilitators/educators/users, mobile collection of disaster points-of-interest.
Facilitators/educators/users, cross-agency collaboration.
Facilitators/educators/users, disconnected data collection and collaboration.
Facilitators/educators/users transmit/receive when available.

The invention use case for Education or “e-Learning” has the following overarching goals:
Prepare users/learners for the daunting challenges we face, by:
   Awareness for proper Scientific Methodology.
   Giving users intimate awareness of the problems facing society.
   Empowering users to help them understand that THEY they are key to the solution.
   Equipping users around the globe with the proper education to help address these global challenges.
Provide a Web/Cloud and mobile based platform for constructing and sharing expert-designed courses. (FIG. 5(A-G))
Feature expert-designed courses (designed by subject matter experts, trainers, and educators) for following problems of global interest:
   Overpopulation and/or food supply.
   Endangered species and/or Threatened Ecosystems.
   Water availability, usage, and contamination.
Allow facilitators/educators to pick a shared, curated course and adapt it to their local sites:
   Facilitators/educators can begin by picking one or more Experimentation/Observation templates (Observational Learning Methods) from the course package, to create a Lesson Plan with one or more phases:
      Preparatory Homework Phase.
      Field Study Phase (One or more field). experiments/observations according to Observation Posts).
      Classroom Phase (Laboratory) Study.
      Final Report Phase (with experiment results, key observations and conclusions).
   Facilitators/educators are allowed to add their own additional Observational Learning Methods (and associated “stories”). Each with Background, Instructions, Exercise Questions to complete the course syllabus.
   Facilitators/educators have flexibility to optionally preselect the field location for the post (for a class field trip), or users/learners working independently can pick a suitable site given general guidance.
Enable facilitators/educators to generate class emails with links to their tailored online course.
Provide the facilitators/educators control of how much of the syllabus is exposed, to stage the lesson plan to the class.
Facilitators/educators can align syllabus with applicable local requirements.

The invention incorporates a set of capabilities, which meet the goals outlined above in the e-Learning Use Case.

The Goals and Objectives of the Invention as an educational immersive, mixed reality, e-Learning, platform, are as follows:
Leverage accessible technology, curriculum, and institutional partners within U.S.
Utilize field sites within the U.S., and proximate to students.
Develop a repeatable process that a facilitator/educator can apply to a study problem (e.g., field trip w/homework assignments, etc.).
Produce expert-created course(s) that features a general-purpose lesson plan that a facilitator/educator can adapt to a local situation.
Each lesson plan is comprised of:
   One or more phases (as defined above).
   One or more Observational Learning Methods for a Field Study Exercise and/or a Classroom Exercise. Each Method has:
      Background material (one or more stories with significant relevant background study content).
      Instructions for students to complete the field/classroom exercise.
      Questions for student to answer.
A facilitator/educator can adapt a curated course to a local study situation and specialized lesson plan:
   Select and pinpoint a pre-specified Observational Learning Method (Field or Lab).
   Optionally add/update a customized Observational Learning Method, using an Editor tool to create/update content.
Optionally, a user can pick the location of the Observational Learning Method, given expert provided guidelines for Site Selection, but students must still follow the lesson plan designed by their instructor.
Means for users to complete field/classroom exercises, compiling observations and notes as they go along. The observations and notes are compiled and shared with facilitator/educator, and optionally classmates for collaborative projects.
Means for user to complete and upload homework assignments and Web-based Final Reports, with linked Supporting Information and References.
End-to-end process and tools for facilitators/educators to curate and deploy lesson plans, and for users/learners to complete field/classroom exercises and homework exercises.
Means for facilitators/educators to review intermediate findings and Final Reports.

I claim the independent invention is:

1. A Secure Cloud Based Platform comprising of; collaborative supplemental pedagogical educational training, and distant e-learning application/website;
wherein; an immersive interactive cooperative space allows single and multiple (UI/UX) users interact with single and/or multi-devices, engage tools and mixed reality, within a semi-open-ended website/application for threaded collaboration,
wherein; data processing and processing management, API's ie; (application programming interface), mixed reality (MR), AI (artificial intelligence), IT (information technology), ITO (information of things), geographical coordinates by global positioning system (GPS),
wherein; authentic cognitive problem-based learning and learning sciences engage users to investigate while leveraging global collaboration through sharing; artifacts, life sciences branching, collection of via mixed reality-based applications, interacting computer-generating virtual world integration with the real world,
wherein; facilitators/educators are able to make use of the platform's high quality framework along with open source resources, tools accompanying supplemental distinctions between physical indoor classroom and outdoor e-learning, transforming and enhancing remote learning capabilities, develop scaffolding supporting the syllabus model, enhancements and projecting them along with annotations or objects,
wherein; developing innovational research findings, systematic methods to: identify analyze, synthesize, well-designed learning material, and supplemental support services, assess curated subject matter experts, innovation research, holistic inquiry perspectives, interface design, blended collaboration to support discover for sustainable innovative solutions, i.e.; environmental biodiversity ecosystems which are affected by industries,
wherein; incorporating relevant several ready-to use themes with stacked built-in functional features such as: STEAM (science, technology, engineering, arts, math), 3D science (scientific, engineering practices (SEPs), disciplinary Core Ideas (DCIs), and crosscutting concepts (CCCs), 4 C's (critical thinking, communication, collaboration, and creativity),
wherein; the platform's application/website framework are opportunities providing facilitator/educators, the ability to integrate additional API's (application program interface), i.e.; computing interface which defines interactions between multiple software intermediaries, spatial patterns, and gamification as a layer, could increase user/learner responsiveness, (i) web-based course curation tools for subject matter experts, facilitators/educators, with the ability to implement multi-media based lesson plans, (ii) a Mobile e-learning application that employs mixed reality techniques to support in situ users/learners conducting field science exercises comprising but not limited to geographical components geo-mapping fencing features, (iii) adaptive reusable tools for compiling/experiencing course integrated content and access to databases,
wherein; the platform's application/website is a set of interactive custom and online services that provides the users to study and interact online while providing users with tools, information and resources i.e.; (augmented, virtual mixed reality, open source hyperlinks, coding, API's, books, videos, etc.), syllabus supplemental studying, interim algorithm progress of the user, and individual results,
wherein the website/application allows users to have mixed reality experiences, with or without connectivity, in which data related to their environment guides exploration, allows users to capture digital information that can be uploaded to secure repository,
wherein; users/learners record their observations about the subject within the website/application, observations become accessible to other: facilitators/educators, users/learners, allows the compiled findings to undertake data-based research, wherein the application enhances the educator's/facilitator's (teacher's, parent's), toolkit to leverage local, real-world resources supporting collaborative, effective, innovative solutions,
wherein; more advanced users/learners can access additional findings, re-evaluate and further expand global discovery,
wherein; the cloud-based secure platform accesses: qualitive, curated, database functionality storage, within the platform's centralized recourse repository (wiki-like library), findings are shared through a system that sits atop a 360-video portal can leverage any type of media as a base, which can in turn be enhanced to provide dimensionality as well as interactivity, i.e.; starting with the Google Earth application, which is accessed by an open set of Application Protocol Interfaces (API's) and creating a 360 rendering of the same,
wherein; the interactive rendering in the portal is constructed as a grid to allow tags to be placed at any point therein, additional information can be added, i.e.; a series of photographs or videos could be uploaded by the user creating the point, in turn another viewer could select that point and see any information that had been uploaded in relation to the said point, information sharing systems, are connected to the tags as well to allow for the provisional of additional information and discussions by all participants,
wherein; the invention's platform is built on a cloud-based infrastructure to ensure scalability and uninterrupted services, depending on the location of user/learner groups, the invention distributes across appropriate geographic nodes to minimize latency,
wherein; the repository of user interactions is captured in a wiki-type format, the material enables facilitators/users curate and facilitate engaging hands-on, mixed reality learning experiences which is continually updated to reflect changes in topic knowledge,
wherein; associated commentary available through deep linking, these two elements allow for the inclusion of both trusted sources and living body of knowledge that continue to engage user/learners overtime,
wherein the invention's platform provides the ability for users to have detailed geographical coordinates information related to any area to reside natively on their Mobil device and leverage this information for enhanced field experiences, once content is obtained and shared, the invention provides guided pathways that support users/learners create collaborative solutions that span multiple disciplines and accounts for multicultural learning environment,
wherein; the layers consist of; a top layer, mixed reality, is user interface and will serve as the initial point of interaction for the user, this will be accessed via a webpage and/or an application and is comprised of renderings of applications that are available from other web services and accessed via customized application program interface (API's), wherein;
the second layer, the content repository, provides storage for images uploaded by a user and allows them to be arranged in a manner of their choosing, this layer will be built with standard HTML, JavaScript, and other web development languages, wherein; the content repository will store all uploaded digital files in a standard content management system and will be viewable through the mixed reality layer, with changes and additions displayed in real time, upon creation of an object in the content repository, a connector includes a social media component,
wherein; the third layer, the social media layer, utilizes common social media components and applications, i.e.; wiki's and/or blogs, this is connected to individual objects in the content media layer via RESTful API's and display contents, which in turn are consumed by the mixed reality layer, the social media layer is connected, by standard connectors to a relational database, precise configuration is dependent upon the social media service being consumed,
wherein; the invention's framework and all of the components described above will be hosted on cloud-based services such as Amazon Web Services and/or Microsoft Azure,
wherein; invention's framework exists in a multi-tenant state so that instances may be created on-demand and provisioned to accompany other learning systems, or as a stand-alone product,
wherein; the invention platform's R&D effort is, “a systematic application of knowledge . . . ”, the invention's technical objective is an innovative mobile e-learning system that enhances critical STEAM e-learning education by integrating classroom experiences with immersive, in situ outdoor learning experiences, where students employ the scientific method to better understand major problems that are now occurring on a global scale,
wherein; the invention's methodology takes emergent “citizen scientists” to the field with science-based, mixed-reality education, e-learning tools, where they can address key scientific questions, measure and observe features and phenomena in their locale, and then bring these results back into the classroom/lab for collaboration to: synthesis, analysis, evaluation, and reporting, the approach of seamlessly blending outdoor learning with classroom/lab activities allow students to research local conditions and issues to achieve a deeper understanding of complex global problems such as overpopulation, climate change, and food/water safety and supply,
wherein; the invention's approach centers on three core ideas for overcoming this challenge: 1) evidence of these problems can be found in every user/leaner locale, so each user/learner can actively participate in relevant scientific investigations: 2) scientist-educators can employ web tools to curate instructional syllabi for user/learner mobile devices, so that independent and/or collaborating user/learner can in turn conduct field exercises/experiments: and 3) authentic, “hands-on” field science, with mobile e-learning tools that apply the scientific method,
wherein; the invention platform is summarized as set of tools that provide for: knowledgeable subject matter experts, facilitators, educators and users/learners to craft place-based experiences using curation tools, while users embark upon expertly curated experiences, in the form of tours and observation posts within the inventions platform's mobile application, geographical geospatial data sharing and analysis services, from cloud providers, performance in both online and offline/intermittent connectivity modes,
wherein; the storytelling and sharing example use case centers around a set of hierarchal concepts or “elements”, “narratives”, “observational learning methods”, “journeys”, and “path identifiers”.
A method of claim 1, comprising of web-based curation open tools that provide for subject matter experts, facilitators, educators and users which can craft place-based experiences.
A method of claim 1, wherein users embark upon expertly curated experiences, in the form of mixed reality, and augmented reality tours comprising of open geospatial data, life science sharing and analysis services from cloud provider.
A method of claim 1, within the platform's framework there are opportunities which provides subject matter experts, facilitators, educators and users/learners, with the ability to personalize and customize their content authorship/publishing scaffolding.
A method of claim 1, wherein the mobile module interface interaction providing a facilitator, educator and user/leaner to have direct control, personal space to share within a cooperative space between users.
A method of claim 1, wherein storytelling and sharing use case centers around a set of hierarchical concepts, comprising elements of narratives, observational learning methods, journeys, journey collections, journey map performance in both online and offline/intermittent partial open connectivity modes.
A method of claim 1, comprising internet-based (API's) open material provide users with visual representations of topics and environments in which they occur for the user to transfer two dimensional representations to a three-dimensional model.
A method of claim 1, wherein consisting essentially of curated information recognized provides cross-referenced authentic learning content within the platform's open central repository characterized in that comprises a network connective module.
